(19) United States
(12) Patent Application Publication
(10) Pub. No.: US 2026/0304471 A1
(43) Pub. Date: Oct. 1, 2026

(54) ACCESS BEFORE AN OFFSET IN A SHARED CHANNEL OCCUPANCY TIME

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Xiaoxia ZHANG, San Diego, CA (US); Stelios STEFANATOS, San Diego, CA (US)

(21) Appl. No.: 19/477,671

(22) PCT Filed: May 8, 2024
(86) PCT No.: PCT/US2024/028304

§ 371 Date: Oct. 22, 2025

(30) Foreign Application Priority Data
Jun. 30, 2023 (GR) 20230100536

(51) Int. Cl. H04W 74/0808

(52) U.S. Cl. CPC H04W 74/0808

(57) ABSTRACT

Various aspects of the present disclosure generally relate to wireless communication. In some aspects, a first user equipment (UE) may receive information for a shared channel occupancy time (COT) of a second UE that indicates an offset in the COT before which the first UE is not able to perform listen-before-talk (LBT) to access the shared COT and after which the first UE is able to perform LBT to access the shared COT. The UE may transmit, to the second UE, sidelink control information that indicates a reserved slot that is reserved for the first UE in the shared COT before the offset. The UE may perform an LBT procedure to perform a transmission at the reserved slot within the shared COT. Numerous other aspects are described.

### CROSS-REFERENCE TO RELATED APPLICATION

This Patent Application claims priority to Greece Patent Application No. 20230100536, filed on Jun. 30, 2023, entitled “ACCESS BEFORE AN OFFSET IN A SHARED CHANNEL OCCUPANCY TIME,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for access before an offset in a shared channel occupancy time.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

A user equipment (UE) may operate in unlicensed sidelink (SL-U). If a first UE (UE1) determines that a channel is clear, UE1 may treat the channel as clear for a maximum duration of time, or for a channel occupancy time (COT). If UE1 does not need to use the whole COT for a sidelink transmission or reception, UE1 may share the COT with another UE, such as with a second UE (UE2). UE1 may indicate resource blocks (RBs) and a time duration for the COT. UE1 may be a COT initiator that performs a channel access procedure (e.g., a listen-before-talk (LBT) procedure) and starts the COT. UE1 may transmit data to UE2 in a sidelink communication during the shared COT. UE2 may be a COT responder and may provide a feedback communication to UE1, in response to the sidelink communication, during the shared COT. UE2 may perform a type 2 LBT procedure. However, if UE2 can attempt to access the channel with LBT Type 2 and transmit anywhere in the COT (after decoding COT sharing information (COT-SI) and before the COT end time marked by the COT remaining duration), there is a chance that UE2 would preempt the channel from being used by UE1. If UE1 cannot transmit in its own COT, UE1's communications will degrade and latency will increase.

UE1 may share the COT and indicate an offset and a duration of the shared COT. UE2 may not access the shared COT before the offset in order to protect UE1's ability to access the shared COT. If UE2 has reserved slots that fall within the shared COT, UE2 cannot access these reserved slots if they occur before the offset. However, if UE1 drops one or two transmissions and does not used the reserved slots, the reserved slots may be wasted. UE2 is not able to use the empty reserved slots because of the offset. Wasted slots waste signaling resources and increase latency.

According to various aspects described herein, UE2 may access (e.g., perform Type 2 LBT) and transmit in reserved slots that are reserved for UE2 and that occur before the offset within a shared COT. UE2 may not transmit between the reserved slots and the offset. UE2 may access and transmit in the region of the shared COT that is after the offset. In this way, UE2 may use the reserved slots if UE1 is not able to use the reserved slots, but a transmission burst by UE2 will not prevent UE1 from accessing the rest of the shared COT before the offset. As a result of this improved shared COT efficiency, signaling resources are not wasted and latency is reduced, while UE1's communications are not delayed or degraded.

Some aspects described herein relate to a method of wireless communication performed by a first UE. The method may include receiving information for a shared COT of a second UE that indicates an offset in the COT before which the first UE is not able to perform LBT to access the shared COT and after which the first UE is able to perform LBT to access the shared COT. The method may include transmitting, to the second UE, sidelink control information (SCI) that indicates a reserved slot that is reserved for the first UE in the shared COT before the offset. The method may include performing an LBT procedure to perform a transmission at the reserved slot within the shared COT.

Some aspects described herein relate to a method of wireless communication performed by a second UE. The method may include transmitting, to a first UE, information for a shared COT of the second UE that indicates an offset in the shared COT before which the first UE is not able to perform LBT to access the shared COT and after which the first UE is able to perform LBT to access the shared COT. The method may include receiving SCI that indicates a reserved slot that is reserved for the first UE in the shared COT before the offset. The method may include dropping a communication by the second UE within the shared COT before the offset based at least in part on the reserved slot. The method may include attempting to resume transmission of the communication by the second UE before the offset.

Some aspects described herein relate to a first UE for wireless communication. The first UE may include one or more memories and one or more processors coupled to the one or more memories. The one or more processors may be individually or collectively configured to cause the first UE to receive information for a shared COT of a second UE that indicates an offset in the COT before which the first UE is not able to perform LBT to access the shared COT and after which the first UE is able to perform LBT to access the shared COT. The one or more processors may be individually or collectively configured to cause the first UE to transmit, to the second UE, SCI that indicates a reserved slot that is reserved for the first UE in the shared COT before the offset. The one or more processors may be individually or collectively configured to cause the first UE to perform an LBT procedure to perform a transmission at the reserved slot within the shared COT.

Some aspects described herein relate to a second UE for wireless communication. The second UE may include one or more memories and one or more processors coupled to the one or more memories. The one or more processors may be individually or collectively configured cause the second UE to transmit, to a first UE, information for a shared COT of the second UE that indicates an offset in the shared COT before which the first UE is not able to perform LBT to access the shared COT and after which the first UE is able to perform LBT to access the shared COT. The one or more processors may be individually or collectively configured to cause the second UE to receive SCI that indicates a reserved slot that is reserved for the first UE in the shared COT before the offset. The one or more processors may be individually or collectively configured to cause the second UE to drop a communication by the second UE within the shared COT before the offset based at least in part on the reserved slot. The one or more processors may be individually or collectively configured to cause the second UE to attempt to resume transmission of the communication by the second UE before the offset.

Some aspects described herein relate to a non-transitory computer-readable medium that stores a set of instructions for wireless communication by a first UE. The set of instructions, when executed by one or more processors of the first UE, may cause the first UE to receive information for a shared COT of a second UE that indicates an offset in the COT before which the first UE is not able to perform LBT to access the shared COT and after which the first UE is able to perform LBT to access the shared COT. The set of instructions, when executed by one or more processors of the first UE, may cause the first UE to transmit, to the second UE, SCI that indicates a reserved slot that is reserved for the first UE in the shared COT before the offset. The set of instructions, when executed by one or more processors of the first UE, may cause the first UE to perform an LBT procedure to perform a transmission at the reserved slot within the shared COT.

Some aspects described herein relate to a non-transitory computer-readable medium that stores a set of instructions for wireless communication by a second UE. The set of instructions, when executed by one or more processors of the second UE, may cause the second UE to transmit, to a first UE, information for a shared COT of the second UE that indicates an offset in the shared COT before which the first UE is not able to perform LBT to access the shared COT and after which the first UE is able to perform LBT to access the shared COT. The set of instructions, when executed by one or more processors of the second UE, may cause the second UE to receive SCI that indicates a reserved slot that is reserved for the first UE in the shared COT before the offset. The set of instructions, when executed by one or more processors of the second UE, may cause the second UE to drop a communication by the second UE within the shared COT before the offset based at least in part on the reserved slot. The set of instructions, when executed by one or more processors of the second UE, may cause the second UE to attempt to resume transmission of the communication by the second UE before the offset.

Some aspects described herein relate to an apparatus for wireless communication. The apparatus may include means for receiving information for a shared COT of another apparatus that indicates an offset in the COT before which the apparatus is not able to perform LBT to access the shared COT and after which the apparatus is able to perform LBT to access the shared COT. The apparatus may include means for transmitting, to the other apparatus, SCI that indicates a reserved slot that is reserved for the apparatus in the shared COT before the offset. The apparatus may include means for performing an LBT procedure to perform a transmission at the reserved slot within the shared COT.

Some aspects described herein relate to an apparatus for wireless communication. The apparatus may include means for transmitting, to another apparatus, information for a shared COT of the apparatus that indicates an offset in the shared COT before which the other apparatus is not able to perform LBT to access the shared COT and after which the other apparatus is able to perform LBT to access the shared COT. The apparatus may include means for receiving SCI that indicates a reserved slot that is reserved for the other apparatus in the shared COT before the offset. The apparatus may include means for dropping a communication by the apparatus within the shared COT before the offset based at least in part on the reserved slot. The apparatus may include means for attempting to resume transmission of the communication by the apparatus before the offset.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of selecting sidelink resources, in accordance with the present disclosure.

FIG. 6 is a diagram illustrating an example of channel occupancy time (COT) sharing issues, in accordance with the present disclosure.

FIG. 7 is a diagram illustrating an example of a COT sharing offset, in accordance with the present disclosure.

FIG. 8 is a diagram illustrating an example of using reserved slots before a COT offset, in accordance with the present disclosure.

FIG. 9 is a diagram illustrating an example of using reserved slots before an offset in a shared COT, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

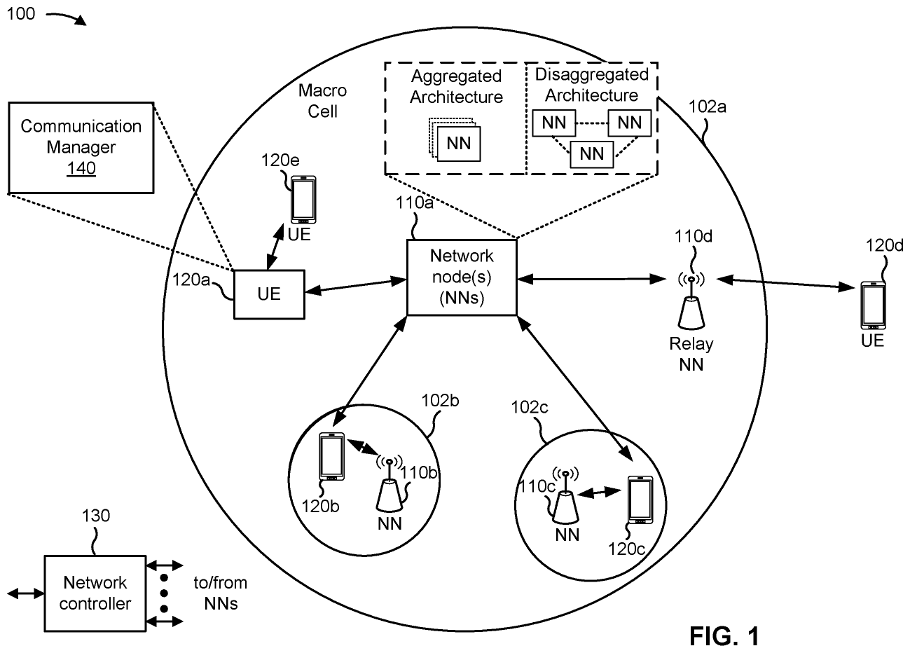

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz).

Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., a UE 120) may include a communication manager 140. As described in more detail elsewhere herein, the communication manager 140 may receive information for a shared channel occupancy time (COT) of a second UE that indicates an offset in the COT before which the first UE is not able to perform LBT to access the shared COT and after which the first UE is able to perform listen-before-talk (LBT) to access the shared COT. The communication manager 140 may transmit, to the second UE, sidelink control information (SCI) that indicates a reserved slot that is reserved for the first UE in the shared COT before the offset. The communication manager 140 may perform an LBT procedure to perform a transmission at the reserved slot within the shared COT.

In some aspects, a second UE (e.g., a UE 120) may include a communication manager 140. As described in more detail elsewhere herein, the communication manager 140 may transmit, to a first UE, information for a shared COT of the second UE that indicates an offset in the shared COT before which the first UE is not able to perform LBT to access the shared COT and after which the first UE is able to perform LBT to access the shared COT. The communication manager 140 may receive SCI that indicates a reserved slot that is reserved for the first UE in the shared COT before the offset. The communication manager 140 may drop a communication by the second UE within the shared COT before the offset based at least in part on the reserved slot. The communication manager 140 may attempt to resume transmission of the communication by the second UE before the offset. Additionally, or alternatively, the communication manager 140 may perform one or more other operations described herein.

As indicated above, FIG. 1 is provided as an example. Other examples may differ from what is described with regard to FIG. 1.

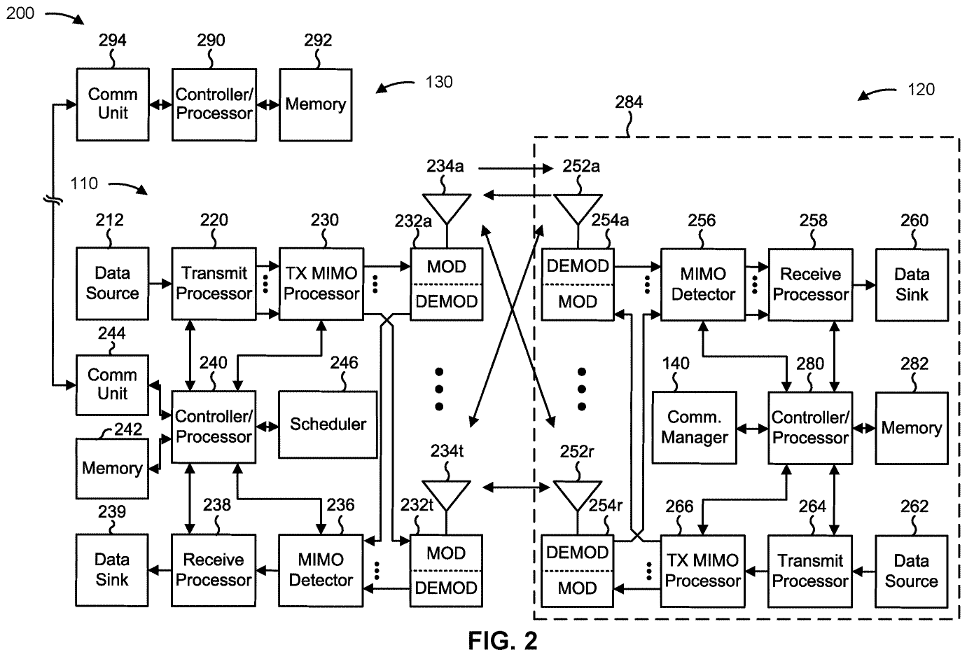

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

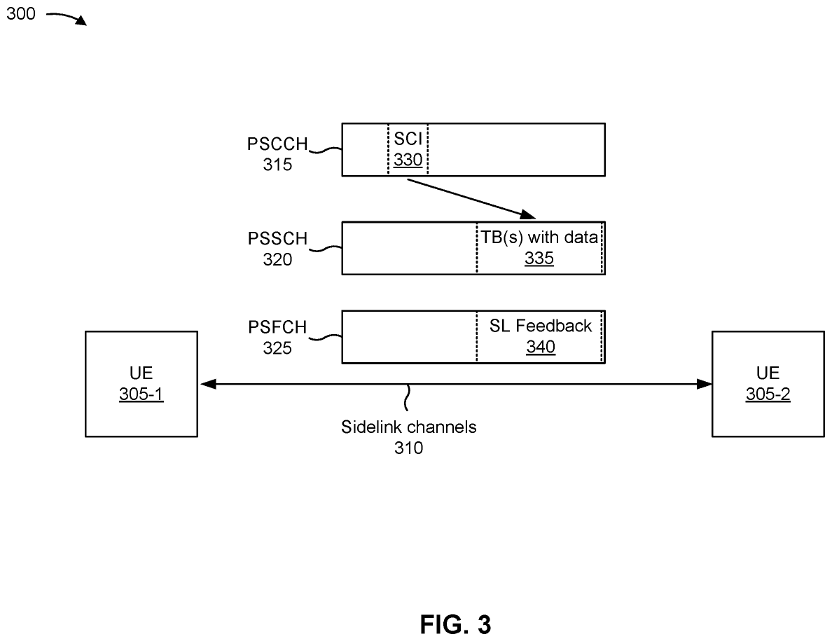

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

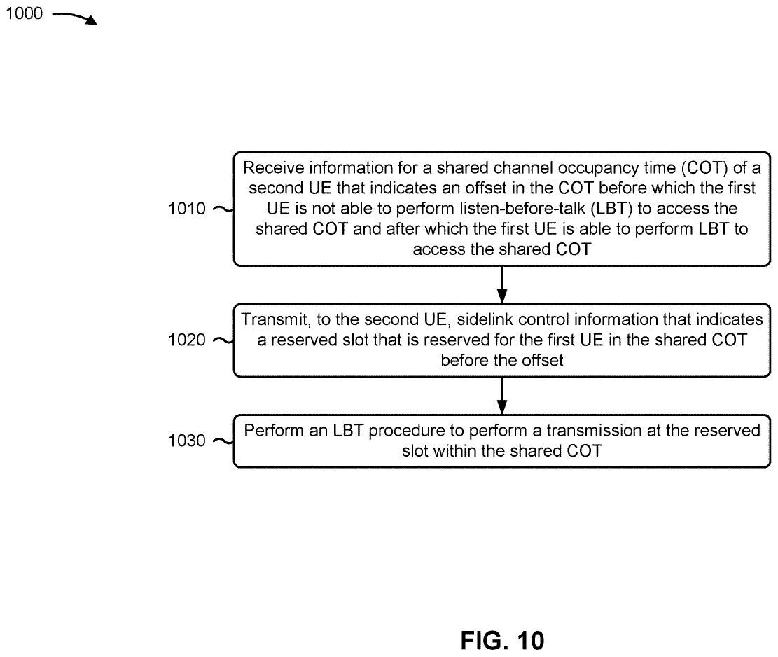

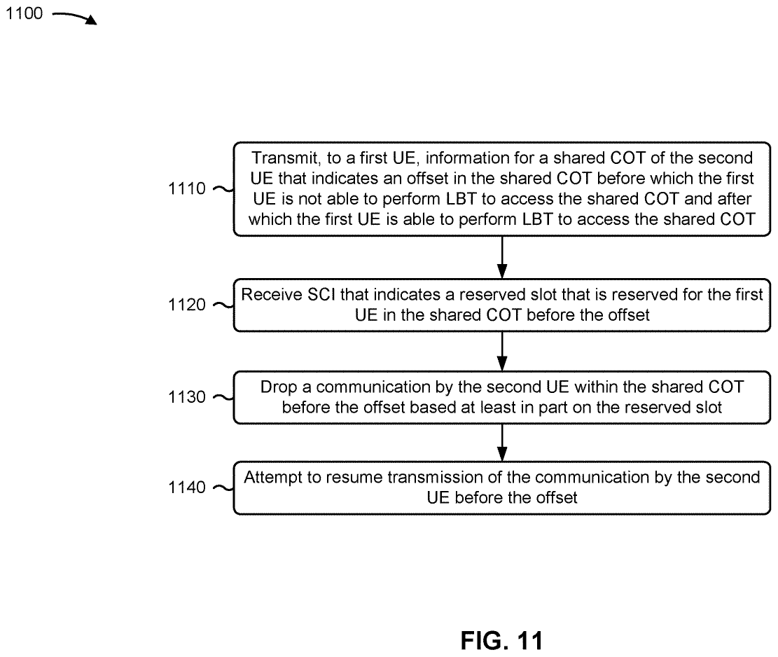

A controller/processor of a network entity (e.g., a controller/processor 240 of the network node 110), the controller/processor 280 of the UE 120, and/or any other component(s) of FIG. 2 may perform one or more techniques associated with accessing a channel before an offset in a shared COT, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein.

The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a first UE (e.g., a UE 120) includes means for receiving information for a shared COT of a second UE that indicates an offset in the COT before which the first UE is not able to perform LBT to access the shared COT and after which the first UE is able to perform LBT to access the shared COT; means for transmitting, to the second UE, SCI that indicates a reserved slot that is reserved for the first UE in the shared COT before the offset; and/or means for performing an LBT procedure to perform a transmission at the reserved slot within the shared COT. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g. a UE 120) includes means for transmitting, to a first UE, information for a shared COT of the second UE that indicates an offset in the shared COT before which the first UE is not able to perform LBT to access the shared COT and after which the first UE is able to perform LBT to access the shared COT; means for receiving SCI that indicates a reserved slot that is reserved for the first UE in the shared COT before the offset; means for dropping a communication by the second UE within the shared COT before the offset based at least in part on the reserved slot; and/or means for attempting to resume transmission of the communication by the second UE before the offset. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC 5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry SCI 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

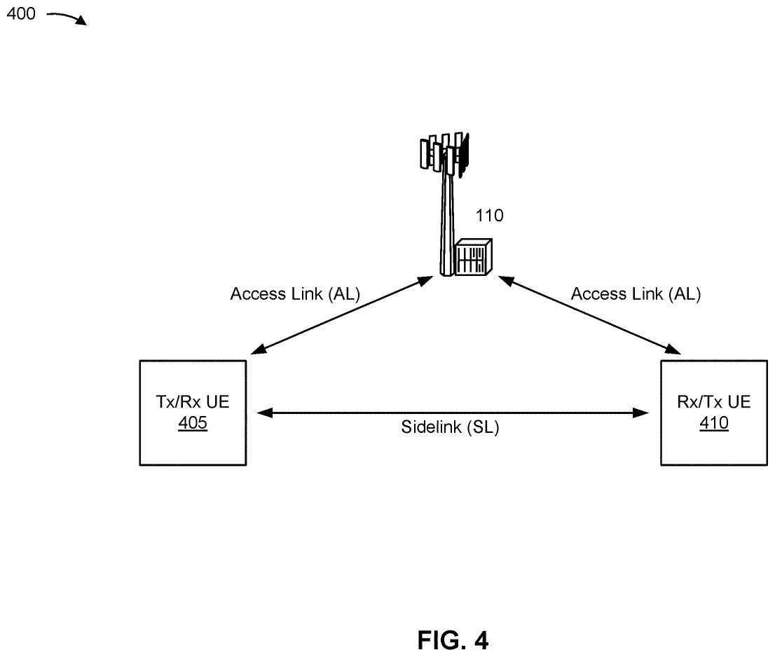

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

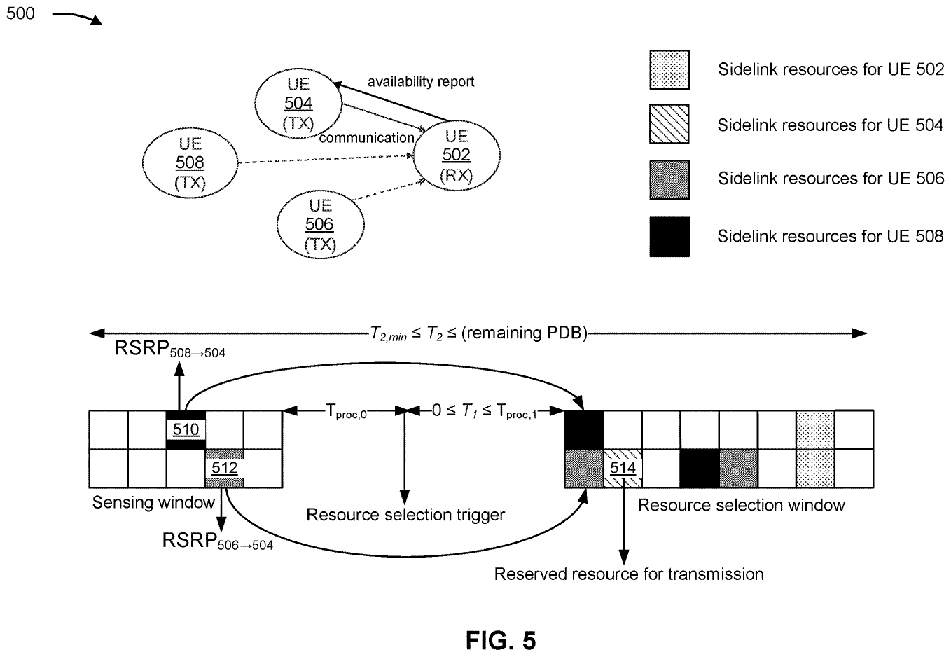

FIG. 5 is a diagram illustrating an example 500 of selecting sidelink resources, in accordance with the present disclosure. Example 500 shows a UE 502 (e.g., a UE 120) that may receive communications on a sidelink channel from other UEs, such as UE 504, UE 506, and/or UE 508.

As described in connection with FIG. 5, UE 504 is a transmitting UE that is transmitting communications to UE 502, which is a receiving UE. UE 504 may use a report from UE 502, which may act as a reporting UE that reports available sidelink resources, preferred sidelink resources, non-preferred sidelink resources, or sidelink resource conflicts. Example 500 shows an availability report from UE 502 to UE 504 and a communication from UE 504 to UE 502.

If UE 504 is to transmit a communication to UE 502, UE 504 may sense the sidelink channel in a sensing window to determine which sidelink resources (e.g., subcarriers, subchannels) are available. UE 504 may use a LBT procedure to sense the channel. The LBT procedure maybe a Type 1 LBT procedure, where UE 504 listens for multiple slots (e.g., 9 milliseconds (ms)) and uses a counter. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 504 may measure DMRSs on a PSCCH or a PSSCH, according to a configuration.

For example, UE 504 may prepare to transmit a communication to UE 502. UE 504 may have already sensed previous sidelink resources and successfully decoded SCI from UE 506 and UE 508. UE 504 may try to reserve sidelink resources, and thus may check the availability of the future sidelink resources reserved by UE 506 and UE 508 by sensing the sidelink channel in the sensing window. UE 504 may measure an RSRP of a signal from UE 508 in sidelink resource 510, and an RSRP of a signal from UE 506 in sidelink resource 512. If an observed RSRP (RSRP projection) satisfies the RSRP threshold (e.g., is lower than a maximum RSRP), the corresponding sidelink resource may be available for reservations by UE 504. UE 504 may reserve the sidelink resource (which may be a random selection from available resources). For example, UE 504 may select and reserve sidelink resource 514 for transmission. This may be in a time slot after which UE 506 and UE 508 had used sidelink resources, and UE 504 may have sensed these sidelink resources earlier. UE 504 may select and reserve sidelink resources only upon reaching a threshold level (e.g., 20%, 30%, or 50% availability). UE 504 may increase or decrease the RSRP threshold as necessary to arrive at the threshold level. UE 504 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

As indicated above, FIG. 5 is provided as an example. Other examples may differ from what is described with regard to FIG. 5.

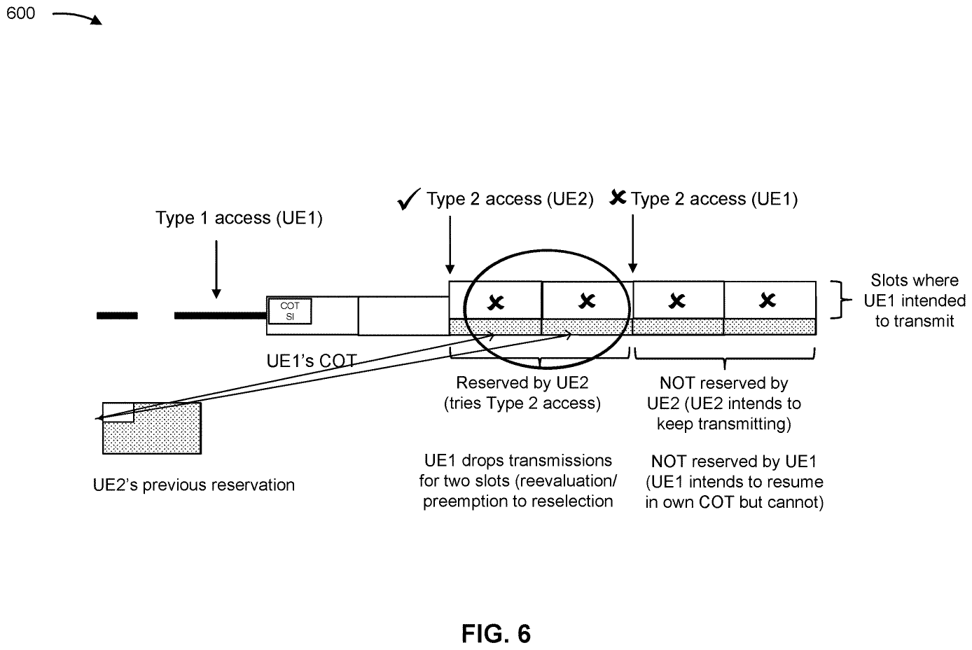

FIG. 6 is a diagram illustrating an example 600 of COT sharing issues, in accordance with the present disclosure.

UEs may operate in unlicensed sidelink (SL-U). If a first UE (UE1) determines that a channel is clear, UE1 may treat the channel as clear for a maximum duration of time, or a COT. If UE1 does not need to use the whole COT for a PSSCH transmission or reception, UE1 may share the COT with another UE, such as with a second UE (UE2). UE1 may indicate RBs and a time duration for the COT. UE1 may be a COT initiator that performs an LBT procedure and starts the COT. UE1 may transmit data to UE2 in a PSSCH communication during the COT. UE2 may be a COT responder and may provide a PSFCH communication to UE1, in response to the PSSCH communication, during the COT. UE2 may be considered to be a PSFCH transmitter. UE2 may perform a type 2 LBT procedure, which is a “one-shot” channel sensing of a much shorter duration (e.g., 16 microseconds (μs)) than a duration of a Type 1 LBT procedure.

A COT interruption gap duration between communications is expected to be 25 μs. If UE1 starts a transmission within the COT interruption gap, UE1 maintains the COT and UE2 is not able to transmit. If UE1 does not start a transmission within the COT interruption gap, UE1 does not maintain the COT and UE2 may transmit. UE2 may perform a Type 2A channel access (16 μs) before transmitting.

Example 600 shows a COT with slots in which UE1 (initiator) intends to transmit. UE1 may share the COT with UE2 (responder) and provide UE2 an indication of a COT remaining duration in COT sharing information (COT-SI). If the time-domain information for the shared COT is provided, it is still unclear how UE1′s transmissions are to be protected. That is, it is unclear in which portion of the remaining COT UE2 can transmit. If UE2 can attempt to access the channel with LBT Type 2 and transmit anywhere in the COT (after decoding COT-SI and before the COT end time marked by the COT remaining duration), there is a chance that UE2 would preempt the channel from being used by UE1. As shown in example 600, UE1 may drop transmissions for two slots due to a reevaluation or preemption check by UE1 that leads to reselection. However, UE2 can access the channel and start a sidelink transmission burst that blocks the future re-access of UE1. The next two slots are not reserved by either UE1 or UE2 and thus UE2 may keep transmitting its burst, which prevents UE1 from resuming transmissions in its own COT (failed Type 2 access by UE1). If UE1cannot transmit in its own COT, UE1′s communications will degrade and latency will increase.

As indicated above, FIG. 6 is provided as an example. Other examples may differ from what is described with regard to FIG. 6.

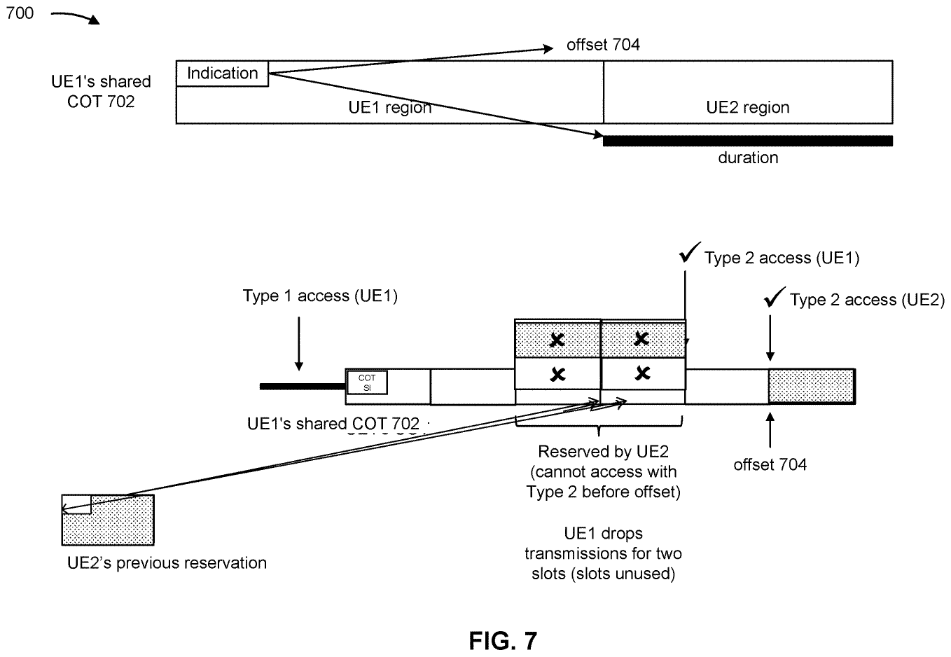

FIG. 7 is a diagram illustrating an example 700 of a COT sharing offset, in accordance with the present disclosure.

In a COT sharing framework in unlicensed NR (NR-U), UE1 may perform Type 1 LBT and obtain a COT. UE1 may share the COT and indicate COT-SI to UE2 that includes an offset and a duration of the shared COT. UE2 may not access the shared COT before the offset in order to protect UE1's ability to access the shared COT. Example 700 shows a shared COT 702 of UE1 with a region before the offset 704 (UE1 region) that UE2 cannot access and a region after the offset 704 (UE2 region) that UE2 can access. UE1 may access (perform Type 2 LBT) and transmit in the shared COT 702 in the UE1 region and the UE2 region. UE2 may access (Type 2 LBT) and transmit in the shared COT 702 only in the UE2 region. A transmission within the shared COT 702 may mean that the transmission is within the RB sets (20 MHz LBT channels) obtained by the Type 1 channel access (or Cat 4 LBT) performed by UE1. In the time domain, the transmission is located between the COT-SI and the maximum COT duration. Different durations may be obtained by performing Type 1 channel access associated with a given channel access priority class (CAPC). Higher priority maps to faster channel access in terms of a smaller random counter and a shorter COT duration.

If UE2 has reserved slots that fall within the shared COT 702, UE2 cannot access these reserved slots if they occur before the offset. However, if UE1 drops one or two transmissions and does not used the reserved slots, the reserved slots may be wasted. UE2 is not able to use the empty reserved slots because of the offset. Wasted slots waste signaling resources and increase latency.

As indicated above, FIG. 7 is provided as an example. Other examples may differ from what is described with regard to FIG. 7.

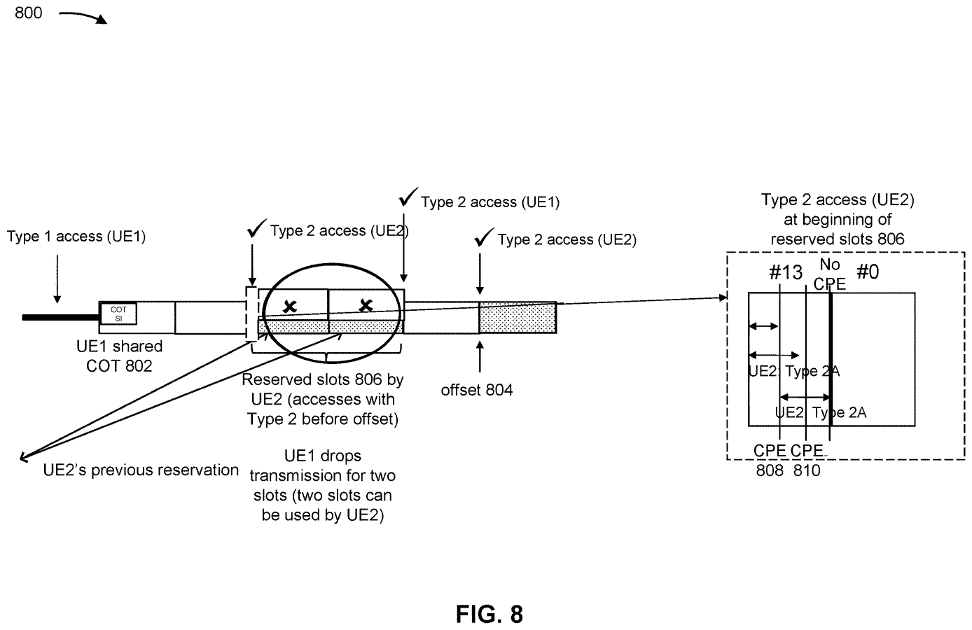

FIG. 8 is a diagram illustrating an example 800 of using reserved slots before a COT offset, in accordance with the present disclosure.

According to various aspects described herein, UE2 may access (e.g., perform Type 2 LBT) and transmit in reserved slots that are reserved for UE2 and that occur before the offset within a shared COT. UE2 may not transmit between the reserved slots and the offset. UE2 may access and transmit in the region of the shared COT that is after the offset. In this way, UE2 may use the reserved slots if UE1 is not able to use the reserved slots, but a transmission burst by UE2 will not prevent UE1 from accessing the rest of the shared COT before the offset. As a result of this improved shared COT efficiency, signaling resources are not wasted and latency is reduced, while UE1′s communications are not delayed or degraded. If UE1 does not drop any transmission, UE1 may continue with its sidelink burst.

Example 800 shows a shared COT 802 of UE1 that has an offset 804. UE1 may perform a Type 1 access (e.g., Type 1 LBT) and obtain the shared COT 802 if the Type 1 access is successful. UE1 may indicate the shared COT 802 (with the duration) and the offset 804. UE2 has indicated to UE1 (e.g., via SCI) that UE2 has reserved slots (e.g., reserved slots 806). UE1 and UE2 both have information that UE2 may access the reserved slots 806 that are before the offset 804. Example 800 shows time points when UE1 and UE2 can access the shared COT 802.

In some aspects, a UE may transmit a cyclic prefix extension (CPE), which includes a start of a transmission in a gap between a first communication and a second communication. The UE may transmit the CPE in order to start transmission at a starting position that is before a scheduled first symbol of the second communication. There may be one or more CPE starting positions before a starting position for a sidelink synchronization signal block (S-SSB), a PSFCH communication, or another physical sidelink channel communication (e.g., PSCCH, PSSCH). The CPE starting position may be configured or indicated.

A CPE may be transmitted from a CPE starting position before a sidelink transmission for the following two options: within the symbol just before the next automatic gain control (AGC) symbol; within the symbol just before the next AGC symbol for 15 kilohertz (kHz) subcarrier spacing (SCS); or within at most 2 symbols just before the next AGC symbol for 30 or 60 kHz SCS.

In some aspects, as shown in example 800, UE2 may select a CPE starting position that is later than a CPE starting position of UE1. This may help UE1 to better succeed in a channel access in its own shared COT. For example, the starting position of CPE 808 may be earlier than the starting position of CPE 810. In some aspects, the LBT may be Type 2A (16 μs), Type 2B (25 μs), or Type 2C (without a CPE and at the start of the next symbol). The Type 2A LBT may be before the AGC symbol.

As indicated above, FIG. 8 is provided as an example. Other examples may differ from what is described with regard to FIG. 8.

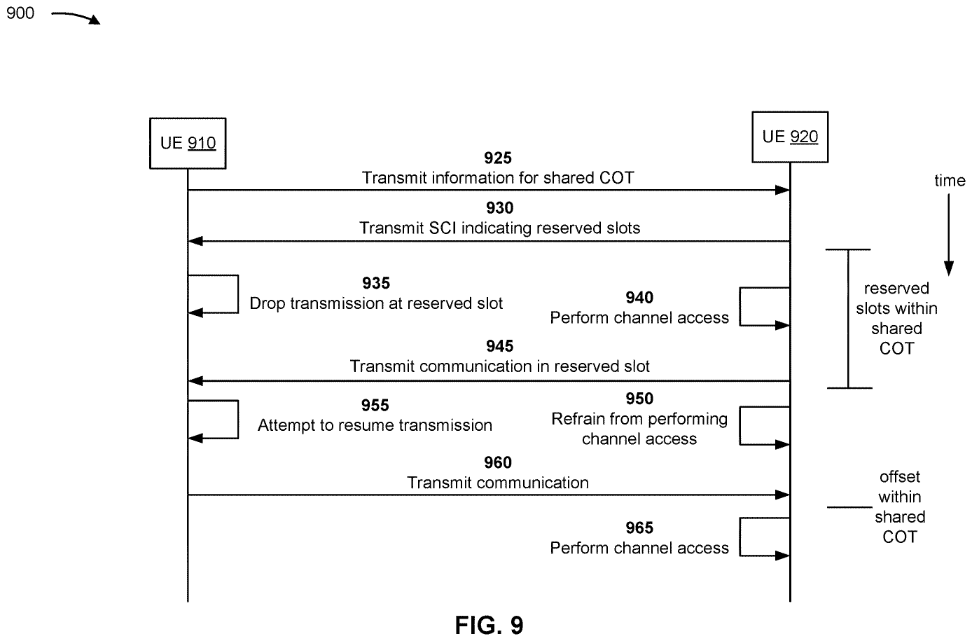

FIG. 9 is a diagram illustrating an example 900 of using reserved slots before an offset in a shared COT, in accordance with the present disclosure.

Example 900 shows a COT initiator UE 910 (e.g., UE 120, UE1) that may communicate with a responder UE 920 (e.g., UE 120, UE2) over a sidelink. Example 900 shows UE 910 initiating a COT and sharing the COT with UE 920. As shown by reference number 925, UE 910 may transmit information for the shared COT. This information may include when the shared COT starts, a duration of the shared COT, and an offset within the shared COT. The offset may be a point within the shared COT (e.g., start of a specified slot) at which UE 920 can access the shared COT. UE 920 may not access the shared COT before the offset unless the access is within one or more reserved slots (e.g., two reserved slots) reserved by UE 920. As shown by reference number 930, UE 920 may transmit SCI that indicates the reserved slots (e.g., by slot index or time within the shared COT).

At some point within the COT, UE 910 may drop one or more transmissions, as shown by reference number 935. The dropping may be due to a reevaluation or preemption check leading to reselection. If the dropping occurs before the reserved slots (reserved by and/or for UE 920), UE 910 may attempt to resume transmission and may be successful (not preempted by UE 920). However, if the dropping occurs at the reserved slots (or such that access may be attempted at the reserved slots), UE 910 may not attempt to resume transmission or perform Type 2 LBT at the reserved slots. Rather than these slots being wasted, as shown by reference number 940, UE 920 may perform channel access (e.g., Type 2A LBT, Type 2B LBT, Type 2C LBT) at the reserved slots (e.g., at or right before first reserved slot). UE 920 may transmit a communication based at least in part on a result of the LBT procedure. For example, if the channel is clear, UE 920 may transmit the communication in a reserved slot, as shown by reference number 945. If the channel is not clear, UE 920 may not transmit a communication.

In some aspects, UE 920 may perform LBT within a specified time window that starts before the reserved slot. After the time window UE 920 may not perform channel access. The specified time window may start at a starting position of a CPE. The specified time window may vary in size and/or may correspond to Type 2A LBT or Type 2B LBT. In some aspects, the transmission may be associated with a CPE at a starting position that is later than a starting position used by UE 910 for a communication in the shared COT. In some aspects, the transmission may not be associated with a CPE.

As shown by reference number 950, UE 920 may refrain from performing channel access after the reserved slots and before the offset. After the reserved slots, UE 910 may attempt to resume transmission, as shown by reference number 955. This may include performing channel access (e.g., Type 2A LBT, Type 2B LBT, Type 2C LBT). In some aspects, UE 910 may attempt to resume transmission based at least in part on a determination that the reserved slot for/by UE 920 is a cause of the dropping. This may be to prioritize UE 910's own transmissions over UE 920's transmissions in the shared COT. The determination may be based at least in part on one or more matching identifiers (IDs) (e.g., target IDs, other criteria). Matching IDs may be equal IDs, paired IDs, or corresponding IDs. For example, the matching IDs may be a source ID and a destination ID for unicast. A first ID may be included in the SCI from UE 920, and a second ID may be included in the information for the COT from UE 910. A first ID may be a destination ID for groupcast or broadcast.

In some aspects, UE 910 may attempt to resume transmission based at least in part on a time gap from an end of the reserved slot not satisfying a gap threshold (e.g., being smaller than a specified gap size). In some aspects, UE 910 may attempt to resume transmission based at least in part on a time gap between two consecutive slots (e.g., one slot for a communication by UE 910 and one slot for a communication by UE 920) being smaller than a threshold time duration. As shown by reference number 960, UE 910 may transmit a communication. After the offset, UE 920 may perform channel access to transmit another communication, as shown by reference number 965.

In some aspects, UE 910 may attempt to resume transmission based at least in part on detection of a communication from UE 920. The communication may be associated with the reserved slot. UE 910 may associate the communication with UE 920 based at least in part on matching IDs.

By allowing UE 920 to access reserved slots before the offset in a shared COT, the use of the shared COT may be more efficient. Signaling resources are conserved and latency is reduced.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120, UE2, UE 920) performs operations associated with channel access before an offset in a shared COT.

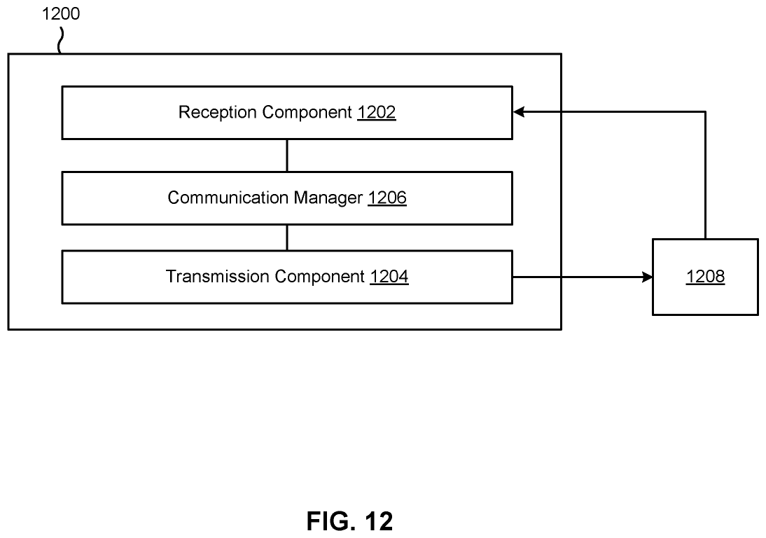

As shown in FIG. 10, in some aspects, process 1000 may include receiving information for a shared COT of a second UE that indicates an offset in the COT before which the first UE is not able to perform LBT to access the shared COT and after which the first UE is able to perform LBT to access the shared COT (block 1010). For example, the UE (e.g., using reception component 1202 and/or communication manager 1206, depicted in FIG. 12) may receive information for a shared COT of a second UE that indicates an offset in the COT before which the first UE is not able to perform LBT to access the shared COT and after which the first UE is able to perform LBT to access the shared COT, as described above.

As further shown in FIG. 10, in some aspects, process 1000 may include transmitting, to the second UE, SCI that indicates a reserved slot that is reserved for the first UE in the shared COT before the offset (block 1020). For example, the UE (e.g., using transmission component 1204 and/or communication manager 1206, depicted in FIG. 12) may transmit, to the second UE, SCI that indicates a reserved slot that is reserved for the first UE in the shared COT before the offset, as described above.

As further shown in FIG. 10, in some aspects, process 1000 may include performing an LBT procedure to perform a transmission at the reserved slot within the shared COT (block 1030). For example, the UE (e.g., using communication manager 1206, depicted in FIG. 12) may perform an LBT procedure to perform a transmission at the reserved slot within the shared COT, as described above.

Process 1000 may include additional aspects, such as any single aspect or any combination of aspects described below and/or in connection with one or more other processes described elsewhere herein.

In a first aspect, process 1000 includes transmitting a communication based at least in part on a result of the LBT procedure.

In a second aspect, alone or in combination with the first aspect, performing the LBT procedure includes performing the LBT procedure within a specified time window that starts before the reserved slot.

In a third aspect, alone or in combination with one or more of the first and second aspects, the LBT procedure includes a type 2A LBT procedure, a type 2B LBT procedure, or a type 2C LBT procedure.

In a fourth aspect, alone or in combination with one or more of the first through third aspects, the transmission from the first UE in the reserved slot is associated with a cyclic prefix extension (CPE) at a starting position that is later than a starting position used by the second UE for a communication in the shared COT.

In a fifth aspect, alone or in combination with one or more of the first through fourth aspects, the transmission is not associated with a CPE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120, UE1, UE 910) performs operations associated with accessing a channel in a shared COT.

As shown in FIG. 11, in some aspects, process 1100 may include transmitting, to a first UE, information for a shared COT of the second UE that indicates an offset in the shared COT before which the first UE is not able to perform LBT to access the shared COT and after which the first UE is able to perform LBT to access the shared COT (block 1110). For example, the UE (e.g., using transmission component 1204 and/or communication manager 1206, depicted in FIG. 12) may transmit, to a first UE, information for a shared COT of the second UE that indicates an offset in the shared COT before which the first UE is not able to perform LBT to access the shared COT and after which the first UE is able to perform LBT to access the shared COT, as described above.

As further shown in FIG. 11, in some aspects, process 1100 may include receiving SCI that indicates a reserved slot that is reserved for the first UE in the shared COT before the offset (block 1120). For example, the UE (e.g., using reception component 1202 and/or communication manager 1206, depicted in FIG. 12) may receive SCI that indicates a reserved slot that is reserved for the first UE in the shared COT before the offset, as described above.

As further shown in FIG. 11, in some aspects, process 1100 may include dropping a communication by the second UE within the shared COT before the offset based at least in part on the reserved slot (block 1130). For example, the UE (e.g., using communication manager 1206, depicted in FIG. 12) may drop a communication by the second UE within the shared COT before the offset based at least in part on the reserved slot, as described above.

As further shown in FIG. 11, in some aspects, process 1100 may include attempting to resume transmission of the communication by the second UE before the offset (block 1140). For example, the UE (e.g., using communication manager 1206, depicted in FIG. 12) may attempt to resume transmission of the communication by the second UE before the offset, as described above.

Process 1100 may include additional aspects, such as any single aspect or any combination of aspects described below and/or in connection with one or more other processes described elsewhere herein.

In a first aspect, attempting to resume transmission includes attempting to resume transmission based at least in part on a determination that the reserved slot for the first UE is a cause of the dropping.

In a second aspect, alone or in combination with the first aspect, attempting to resume transmission includes attempting to resume transmission further based at least in part on a time gap, from an end of the reserved slot, being smaller than a gap threshold.

In a third aspect, alone or in combination with one or more of the first and second aspects, attempting to resume transmission includes attempting to resume transmission further based at least in part on a time gap between two consecutive slots being smaller than a threshold time duration, and the two consecutive slots are for the communication by the second UE and a communication by the first UE.

In a fourth aspect, alone or in combination with one or more of the first through third aspects, the determination is based at least in part on one or more matching IDs.

In a fifth aspect, alone or in combination with one or more of the first through fourth aspects, a first ID of the one or more matching IDs is included in the SCI.

In a sixth aspect, alone or in combination with one or more of the first through fifth aspects, a second ID of the one or more matching IDs is included in the information for the shared COT.

In a seventh aspect, alone or in combination with one or more of the first through sixth aspects, the one or more matching IDs include a pair of source and destination IDs for unicast.

In an eighth aspect, alone or in combination with one or more of the first through seventh aspects, a first ID of the one or more matching IDs includes a destination ID for groupcast.

In a ninth aspect, alone or in combination with one or more of the first through eighth aspects, a first ID of the one or more matching IDs includes a destination ID for broadcast.

In a tenth aspect, alone or in combination with one or more of the first through ninth aspects, attempting to resume transmission includes attempting to resume transmission based at least in part on a detection of a communication from the first UE.

In an eleventh aspect, alone or in combination with one or more of the first through tenth aspects, the communication from the first UE is associated with the reserved slot.

In a twelfth aspect, alone or in combination with one or more of the first through eleventh aspects, attempting to resume transmission includes attempting to resume transmission further based at least in part on a time gap, from an end of the communication from the first UE that is detected, being smaller than a gap threshold.

In a thirteenth aspect, alone or in combination with one or more of the first through twelfth aspects, attempting to resume transmission includes attempting to resume transmission further based at least in part on a time gap between two consecutive slots being smaller than a gap threshold, and the two consecutive slots are for the communication by the second UE and a communication by the first UE.

In a fourteenth aspect, alone or in combination with one or more of the first through thirteenth aspects, process 1100 includes associating the communication by the first UE with the reserved slot based at least in part on one or more matching IDs.

In a fifteenth aspect, alone or in combination with one or more of the first through fourteenth aspects, a first ID of the one or more matching IDs is included in the SCI.

In a sixteenth aspect, alone or in combination with one or more of the first through fifteenth aspects, a second ID of the one or more matching IDs is included in the information for the shared COT.

In a seventeenth aspect, alone or in combination with one or more of the first through sixteenth aspects, the one or more matching IDs include a pair of source and destination IDs for unicast.

In an eighteenth aspect, alone or in combination with one or more of the first through seventeenth aspects, a first ID of the one or more matching IDs includes a destination ID for groupcast.

In a nineteenth aspect, alone or in combination with one or more of the first through eighteenth aspects, a first ID of the one or more matching IDs includes a destination ID for broadcast.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 120, UE1, UE2, UE 910, UE 920), or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

In some aspects associated with a first UE (e.g., a COT responder UE), the reception component 1202 may receive information for a shared COT of a second UE that indicates an offset in the COT before which the first UE is not able to perform LBT to access the shared COT and after which the first UE is able to perform LBT to access the shared COT. The transmission component 1204 may transmit, to the second UE, SCI that indicates a reserved slot that is reserved for the first UE in the shared COT before the offset. The communication manager 1206 may perform an LBT procedure to perform a transmission at the reserved slot within the shared COT. The transmission component 1204 may transmit a communication based at least in part on a result of the LBT procedure.

In some aspects associated with a second UE (e.g., a COT initiator UE), the transmission component 1204 may transmit, to a first UE, information for a shared COT of the second UE that indicates an offset in the shared COT before which the first UE is not able to perform LBT to access the shared COT and after which the first UE is able to perform LBT to access the shared COT. The reception component 1202 may receive SCI that indicates a reserved slot that is reserved for the first UE in the shared COT before the offset. The communication manager 1206 may drop a communication by the second UE within the shared COT before the offset based at least in part on the reserved slot. The communication manager 1206 may attempt to resume transmission of the communication by the second UE before the offset.

In some aspects, the communication manager 1206 may associate the communication by the first UE with the reserved slot based at least in part on one or more matching IDs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first UE, comprising: receiving information for a shared channel occupancy time (COT) of a second UE that indicates an offset in the COT before which the first UE is not able to perform listen-before-talk (LBT) to access the shared COT and after which the first UE is able to perform LBT to access the shared COT; transmitting, to the second UE, sidelink control information that indicates a reserved slot that is reserved for the first UE in the shared COT before the offset; and performing an LBT procedure to perform a transmission at the reserved slot within the shared COT.

Aspect 2: The method of Aspect 1, further comprising transmitting a communication based at least in part on a result of the LBT procedure.

Aspect 3: The method of any of Aspects 1-2, wherein performing the LBT procedure includes performing the LBT procedure within a specified time window that starts before the reserved slot.

Aspect 4: The method of Aspect 3, wherein the LBT procedure includes a type 2A LBT procedure, a type 2B LBT procedure, or a type 2C LBT procedure.

Aspect 5: The method of any of Aspects 1-4, wherein the transmission from the first UE in the reserved slot is associated with a cyclic prefix extension (CPE) at a starting position that is later than a starting position used by the second UE for a communication in the shared COT.

Aspect 6: The method of any of Aspects 1-5, wherein the transmission is not associated with a cyclic prefix extension (CPE).

Aspect 7: A method of wireless communication performed by a second UE, comprising: transmitting, to a first UE, information for a shared channel occupancy time (COT) of the second UE that indicates an offset in the shared COT before which the first UE is not able to perform listen-before-talk (LBT) to access the shared COT and after which the first UE is able to perform LBT to access the shared COT; receiving sidelink control information (SCI) that indicates a reserved slot that is reserved for the first UE in the shared COT before the offset; dropping a communication by the second UE within the shared COT before the offset based at least in part on the reserved slot; and attempting to resume transmission of the communication by the second UE before the offset.

Aspect 8: The method of Aspect 7, wherein attempting to resume transmission includes attempting to resume transmission based at least in part on a determination that the reserved slot for the first UE is a cause of the dropping.

Aspect 9: The method of Aspect 8, wherein attempting to resume transmission includes attempting to resume transmission further based at least in part on a time gap, from an end of the reserved slot, being smaller than a gap threshold.

Aspect 10: The method of Aspect 8, wherein attempting to resume transmission includes attempting to resume transmission further based at least in part on a time gap between two consecutive slots being smaller than a threshold time duration, and wherein the two consecutive slots are for the communication by the second UE and a communication by the first UE.

Aspect 11: The method of Aspect 8, wherein the determination is based at least in part on one or more matching identifiers (IDs).

Aspect 12: The method of Aspect 11, wherein a first ID of the one or more matching IDs is included in the SCI.

Aspect 13: The method of Aspect 12, wherein a second ID of the one or more matching IDs is included in the information for the shared COT.

Aspect 14: The method of Aspect 11, wherein the one or more matching IDs include a pair of source and destination IDs for unicast.

Aspect 15: The method of Aspect 11, wherein a first ID of the one or more matching IDs includes a destination ID for groupcast.

Aspect 16: The method of Aspect 11, wherein a first ID of the one or more matching IDs includes a destination ID for broadcast.

Aspect 17: The method of any of Aspects 7-16, wherein attempting to resume transmission includes attempting to resume transmission based at least in part on a detection of a communication from the first UE.

Aspect 18: The method of Aspect 17, wherein the communication from the first UE is associated with the reserved slot.

Aspect 19: The method of Aspect 17, wherein attempting to resume transmission includes attempting to resume transmission further based at least in part on a time gap, from an end of the communication from the first UE that is detected, being smaller than a gap threshold.

Aspect 20: The method of Aspect 17, wherein attempting to resume transmission includes attempting to resume transmission further based at least in part on a time gap between two consecutive slots being smaller than a gap threshold, and wherein the two consecutive slots are for the communication by the second UE and a communication by the first UE.

Aspect 21: The method of Aspect 17, further comprising associating the communication by the first UE with the reserved slot based at least in part on one or more matching identifiers (IDs).

Aspect 22: The method of Aspect 21, wherein a first ID of the one or more matching IDs is included in the SCI.

Aspect 23: The method of Aspect 22, wherein a second ID of the one or more matching IDs is included in the information for the shared COT.

Aspect 24: The method of Aspect 21, wherein the one or more matching IDs include a pair of source and destination IDs for unicast.

Aspect 25: The method of Aspect 21, wherein a first ID of the one or more matching IDs includes a destination ID for groupcast.

Aspect 26: The method of Aspect 21, wherein a first ID of the one or more matching IDs includes a destination ID for broadcast.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first user equipment (UE) for wireless communication, comprising:
one or more memories; and
one or more processors coupled to the one or more memories, the one or more processors individually or collectively configured to cause the first UE to:
receive information for a shared channel occupancy time (COT) of a second UE that indicates an offset in the COT before which the first UE is not able to perform listen-before-talk (LBT) to access the shared COT and after which the first UE is able to perform LBT to access the shared COT;
transmit, to the second UE, sidelink control information that indicates a reserved slot that is reserved for the first UE in the shared COT before the offset; and
perform an LBT procedure to perform a transmission at the reserved slot within the shared COT.

2. The first UE of claim 1, wherein the one or more processors are individually or collectively configured to cause the first UE to transmit a communication based at least in part on a result of the LBT procedure.

3. The first UE of claim 1, wherein the one or more processors, to perform the LBT procedure, are individually or collectively configured to cause the first UE to perform the LBT procedure within a specified time window that starts before the reserved slot.

4. The first UE of claim 3, wherein the LBT procedure includes a type 2A LBT procedure, a type 2B LBT procedure, or a type 2C LBT procedure.

5. The first UE of claim 1, wherein the transmission from the first UE in the reserved slot is associated with a cyclic prefix extension (CPE) at a starting position that is later than a starting position used by the second UE for a communication in the shared COT.

6. The first UE of claim 1, wherein the transmission is not associated with a cyclic prefix extension (CPE).

7. A second user equipment (UE) for wireless communication, comprising:
one or more memories; and
one or more processors, coupled to the one or more memories, the one or more processors individually or collectively configured to cause the second UE to:
transmit, to a first UE, information for a shared channel occupancy time (COT) of the second UE that indicates an offset in the shared COT before which the first UE is not able to perform listen-before-talk (LBT) to access the shared COT and after which the first UE is able to perform LBT to access the shared COT;
receive sidelink control information (SCI) that indicates a reserved slot that is reserved for the first UE in the shared COT before the offset;
drop a communication by the second UE within the shared COT before the offset based at least in part on the reserved slot; and
attempt to resume transmission of the communication by the second UE before the offset.

8. The second UE of claim 7, wherein the one or more processors, to attempt to resume transmission, individually or collectively configured to cause the second UE to attempt to resume transmission based at least in part on a determination that the reserved slot for the first UE is a cause of the dropping.

9. The second UE of claim 8, wherein the one or more processors, to attempt to resume transmission, are individually or collectively configured to cause the second UE to attempt to resume transmission further based at least in part on a time gap, from an end of the reserved slot, being smaller than a gap threshold.

10. The second UE of claim 8, wherein the one or more processors, to attempt to resume transmission, are individually or collectively configured to cause the second UE to attempt to resume transmission further based at least in part on a time gap between two consecutive slots being smaller than a threshold time duration, and wherein the two consecutive slots are for the communication by the second UE and a communication by the first UE.

11. The second UE of claim 8, wherein the determination is based at least in part on one or more matching identifiers (IDs).

12. The second UE of claim 11, wherein a first ID of the one or more matching IDs is included in the SCI.

13. The second UE of claim 12, wherein a second ID of the one or more matching IDs is included in the information for the shared COT.

14. The second UE of claim 11, wherein the one or more matching IDs include a pair of source and destination IDs for unicast.

15. The second UE of claim 11, wherein a first ID of the one or more matching IDs includes a destination ID for groupcast.

16. The second UE of claim 11, wherein a first ID of the one or more matching IDs includes a destination ID for broadcast.

17. The second UE of claim 7, wherein the one or more processors, to attempt to resume transmission, are individually or collectively configured to cause the second UE to attempt to resume transmission based at least in part on a detection of a communication from the first UE.

18. The second UE of claim 17, wherein the communication from the first UE is associated with the reserved slot.

19. The second UE of claim 17, wherein the one or more processors, to attempt to resume transmission, are individually or collectively configured to cause the second UE to attempt to resume transmission further based at least in part on a time gap, from an end of the communication from the first UE that is detected, being smaller than a gap threshold.

20-26. (canceled)

27. A method of wireless communication performed by a first user equipment (UE), comprising:
receiving information for a shared channel occupancy time (COT) of a second UE that indicates an offset in the COT before which the first UE is not able to perform listen-before-talk (LBT) to access the shared COT and after which the first UE is able to perform LBT to access the shared COT;
transmitting, to the second UE, sidelink control information that indicates a reserved slot that is reserved for the first UE in the shared COT before the offset; and
performing an LBT procedure to perform a transmission at the reserved slot within the shared COT.

28-30. (canceled)
